(19) United States
(12) Patent Application Publication
(10) Pub. No.: US 2021/0047468 A1
(43) Pub. Date: Feb. 18, 2021

(54) POLYAMIDE PARTICLES AND METHOD FOR PRODUCING POLYAMIDE PARTICLES

(71) Applicant: KUREHA CORPORATION, Tokyo (JP)

(72) Inventors: Daisuke MURANO, Tokyo (JP); Kazuyuki YAMANE, Tokyo (JP); Yingge XIAO, Tokyo (JP); Yoshinori SUZUKI, Tokyo (JP)

(73) Assignee: KUREHA CORPORATION, Tokyo (JP)

(21) Appl. No.: 17/085,270

(22) Filed: Oct. 30, 2020

Related U.S. Application Data
(62) Division of application No. 16/476,934, filed on Jul. 10, 2019.

(30) Foreign Application Priority Data
Feb. 14, 2017 (JP) 2017-025388

(51) Int. Cl. C08G 69/24; C08G 69/16; C08J 3/14

(52) U.S. Cl. CPC C08G 69/24; C08J 3/14; C08G 69/16

(57) ABSTRACT

Provided are non-spherical polyamide particles having small variations in particle shape. The polyamide particles include a polyamide including repeating structural units having at least one alkylene group and at least one amide bond, wherein each of the at least one alkylene group has 1 to 3 carbon atoms. The main shape of the particles is a non-spherical shape with a circularity of less than 0.98, and a coefficient of variation (CV) of the circularity distribution is 30% or less.

### CROSS-REFERENCE TO RELATED APPLICATIONS

This application is a Divisional application of co-pending application Ser. No. 16/476,934, filed on Jul. 10, 2019, which is the National Phase under 35 U.S.C. § 371 of International Application No. PCT/JP2018/002214, filed on Jan. 25, 2018, which claims the benefit under 35 U.S.C. § 119(a) to Patent Application No. 2017-025388, filed in Japan on Feb. 14, 2017, all of which are hereby expressly incorporated by reference into the present application.

### TECHNICAL FIELD

The present invention relates to particles of polyamide particles and a method for producing the same.

### BACKGROUND ART

Polyamide particles are used not only in the fields of cosmetics and industrial products, but also in a wide range of fields, and various polyamide particles have been developed. For example, Patent Document 1 discloses sponge-like polyamide particles having a substantially spherical outer shape and including holes in an outer surface part and an interior portion.

Among polyamide particles, for example, polyamide 4 and the like are known as biodegradable plastics. Among these, polyamide 4 is expected to be used in multiple applications due to its high hygroscopicity.

### CITATION LIST

### Patent Literature

Patent Document 1: WO 2010/101134

### Non-Patent Literature

Non-Patent Document 1: “Alkali-catalyzed polymerization of α-pyrrolidone in the presence of N,N′-adipyl-dipyrrolidone”, Masakazu TANIYAMA, Takashi NAGAOKA, Toshihiro TAKADA, Kazunori SANUYAMA, Journal of the Chemical Society of Japan, Industrial Chemistry Section, Vol. 65, No. 3, 1962, pp. 419-422

### SUMMARY OF INVENTION

### Technical Problems

In many applications, the shape and particle size of the polyamide particles are desired to be uniform. In order to make the particle size uniform, a method of pulverizing and sieving the obtained polyamide particles or the like is conceivable. However, a problem with such a method is that the manufacture becomes complicated by the inclusion of pulverization and sieving steps.

In addition, as the applications of polyamide 4 expand, there may be cases in which non-spherical particles are desired rather than that having the substantially spherical outer shape. However, the technique described in Patent Document 1 is a technique for producing substantially spherical polyamide particles, and Patent Document 1 does not disclose that other uniformly shaped particles than the spherical particle are produced.

In light of the foregoing, an object of the present invention is to provide non-spherical polyamide particles having small variations in particle shape.

### Solution to Problems

In order to solve the problems described above, the polyamide particles according to the present invention includes a polyamide including repeating structural units having at least one alkylene group and at least one amide bond, each of the at least one alkylene group having 1 to 3 carbon atoms; and the polyamide particles have a configuration in which the main shape of the particles is a non-spherical shape with a circularity of less than 0.98 and in which a coefficient of variation (CV) of the circularity distribution is 30% or less.

In order to solve the problems described above, a method for producing polyamide particles according to the present invention includes: a polymerization step of preparing, through polymerization, a polyamide including repeating structural units having at least one alkylene group and at least one amide bond, each of the at least one alkylene group having 1 to 3 carbon atoms; a dissolution step of dissolving the polyamide obtained in the polymerization step in hot water; and a precipitation step of precipitating particles of the polyamide by cooling a solution obtained in the dissolution step under stirring.

### Advantageous Effects of Invention

According to the present invention, non-spherical polyamide particles having small variations in particle shape can be provided.

### BRIEF DESCRIPTION OF DRAWINGS

FIG. 1 is an SEM image of polyamide particles obtained in Example 1. The scale bar represents 5 μm.

FIG. 2 is an SEM image of polyamide particles obtained in Example 2. The scale bar represents 5 μm.

FIG. 3 is an SEM image of polyamide particles obtained in Example 3. The scale bar represents 5 μm.

FIG. 4 is an SEM image of polyamide particles obtained in Example 4. The scale bar represents 5 μm.

FIG. 5 is an SEM image of polyamide particles obtained in Example 5. The scale bar represents 5 μm.

FIG. 6 is an SEM image of polyamide particles obtained in Example 6. The scale bar represents 5 μm.

### DESCRIPTION OF EMBODIMENTS

An embodiment of the polyamide particles and method for producing the same according to the present invention is described hereinafter.

### Polyamide Particles

The polyamide particles in the present embodiment each comprise a polyamide including repeating structural units having at least one alkylene group and at least one amide bond, each of the at least one alkylene group having 1 to 3 carbon atoms.

The above-mentioned structural unit is not particularly limited as long as the structural unit has at least one alkylene group and at least one amide bond, but the structural unit preferably has one or two alkylene groups. The structural unit also preferably has one or two amide bonds.

The number of the repeating structural units may be appropriately determined according to the weight average molecular weight of the polyamide. The weight average molecular weight of the polyamide is described below.

The alkylene groups contained in the structural unit are not particularly limited provided that the number of carbon atoms is from 1 to 3, but the number of carbon atoms is more preferably 2 or 3, and particularly preferably 3. In addition, the alkylene group may be linear or branched.

An example of an aspect of the structural unit according to the present embodiment is a structural unit represented by Formula (1) below.

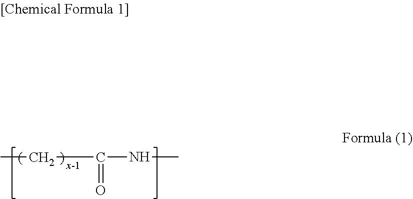

In Formula (1), x is 2, 3, or 4.

An example of another aspect of the structural unit according to the present embodiment is a structural unit represented by Formula (2) below.

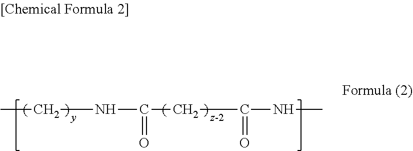

In Formula (2), y is 2 or 3, and z is 2, 3, or 4.

In the present specification, a polyamide having structural units represented by Formula (1) may be referred to as a “polyamide x” according to the number used for x in Formula (1). Thus, for example, a polyamide for which x in Formula (1) is 4 is referred to as “polyamide 4”.

The weight average molecular weight (Mw) of the polyamide according to the present embodiment is not particularly limited, but it is preferably from 30,000 to 800,000, and more preferably from 50,000 to 500,000. When the weight average molecular weight of the polyamide is within this range, non-spherical particles are easily obtained.

The polyamide particles of the present embodiment are of non-spherical main shape having a circularity of less than 0.98, preferably less than 0.95, and more preferably less than 0.90.

In the present specification, the circularity is a value that is determined with respect to individual particles by Equation (3) below, where L is a total outer perimeter of the shape when the particles are viewed from one direction, and S is the surface area of the shape.

Circularity=4π·S/L² (3)

In addition, the fact that the main shape of the particles is a non-spherical shape with a circularity of less than 0.98 does not necessarily mean that all the particles have a non-spherical shape with a circularity of less than 0.98, and particles having a circularity of not less than 0.98 and spherical particles may also be included. Thus, the fact that the main shape of the particles is a non-spherical shape with a circularity of less than 0.98 may be, for example, an aspect in which 50% or more, 70% or more, or 90% or more of the particles contained in the polyamide particles are non-spherical shapes having a circularity of less than 0.98.

In the present specification, the matter of particles being a non-spherical shape means the particles are of a shape that does not meet the requirement for a spherical shape. The requirement for a spherical shape is a sphere with a sphericity of 80 or more, and spherical particles having a sphericity of less than 80 are non-spherical. Examples of non-spherical particles include rod-shaped particles. In addition, non-spherical particles include those having a shape for which it is difficult to determine the sphericity because of the difficulty in identifying the long diameter and the short diameter. Examples thereof include unevenly shaped particles such as dumbbell-shaped particles and particles fused together, as well as irregularly shaped particles such as those with indefinite shapes that do not correspond to any of these.

In the present specification, sphericity is a value calculated in accordance with Equation (4) below by measuring the short diameter and the long diameter for a quantity n of arbitrarily selected poly amide fine particles.

(Equation 1)

Sphericity=[(Σ(short diameter/long diameter))/n]×100 (4)

Note that 30 is suitably used as n.

In order to accurately measure the short diameter and the long diameter of the polyamide fine particles in the present embodiment, preferably, a scanning electron microscope (SEM) image is captured for the polyamide fine particles, and the short diameter and the long diameter of the polyamide fine particles are measured from the captured SEM image.

The circularity of the main shape of the particles may be less than 0.98, but the circularity of the main shape of the particles may also be less than 0.95 or may be less than 0.90.

In the present embodiment, the coefficient of variation (hereinafter, referred to as the CV value) of the circularity distribution of the polyamide particles is 30% or less, preferably 29% or less, more preferably 28% or less, and particularly preferably 25% or less. When the CV value of the circularity distribution is 30% or less, variations in the circularity are small even with polyamide particles for which the particles are non-spherical, and uniformly shaped non-spherical particles are easily obtained.

The CV value represents the degree of dispersion in the circularity distribution of the polyamide particles and can be calculated according to the following equation based on a circularity distribution measured, for example, by a flow-type particle image analyzer (FPIA-3000: available from Sysmex Corporation).

CV Value (%)=[(Standard deviation in circularity distribution)/(average value of circularity distribution)]×100

The average particle size of the polyamide particles in the present embodiment is not particularly limited, but is typically from 1 μm to 300 μm, preferably from 1 μm to 100 μm, and more preferably from 1 μm to 50 μm. Note that the particle size of the individual particles in the polyamide particles of the present embodiment refers to the long diameter of the shape when determining the circularity described above.

In addition, for the polyamide particles of the present embodiment, the D90/D50 value of the particle size distribution of the polyamide particles is preferably 10 or less, more preferably 8 or less, and particularly preferably 5 or less. When the D90/D50 value of the particle size distribution is set to 10 or less, variations in the particle size are small even with polyamide particles for which the particles are non-spherical, and non-spherical particles with a uniform particle size are easily obtained.

### Method for Producing Polyamide Particles

The method for producing the polyamide particles according to the present embodiment will be described below.

The polyamide particles according to the present embodiment are produced through a step of preparing a polyamide, a dissolution step in which the polyamide is dissolved in hot water, and a precipitation step in which particles of polyamide are precipitated. Note that, in the method for producing polyamide particles according to the present embodiment, a case is described in which a polymerization step of obtaining the polyamide through polymerization is used as the step of preparing the polyamide.

### (1) Polymerization Step

The polyamide used in the production method according to the present embodiment is not particularly limited as long as it is a polyamide that includes repeating structural units having at least one alkylene group and at least one amide bond, each of the at least one alkylene group having 1 to 3 carbon atoms, as described above. A method for synthesizing such a polyamide is exemplified below.

### First Polyamide Synthesis Method

A first polyamide synthesis method is for example a ring-opening polymerization using an organic compound having a lactam structure as a raw material. An example of the organic compound having a lactam structure is α-pyrrolidone. The method of ring-opening polymerization is not particularly limited, and examples thereof include known methods such as bulk polymerization and particle polymerization in a petroleum-based solvent.

More specifically, in this method, the polyamide is synthesized by, for example, subjecting the above-described organic compound having a lactam structure to hydrolysis to open the ring and then subjecting the product to dehydration condensation. Here, the following procedure may also be selected. That is, an anionic ring-opening polymerization method may be used in which a small amount of a base is reacted with an organic compound having a lactam structure to generate an anionic species, and the anionic species induce ring opening of the organic compound having a lactam structure, resulting in chain extension.

### Second Polyamide Synthesis Method

A second polyamide synthesis method is for example a method of self-condensation of amino acids. Examples of amino acids include glycine and γ-aminobutanoic acid.

More specifically, in this method, the polyamide is synthesized by subjecting the amino acids to dehydration condensation by heating under reduced pressure. Here, the following procedure may also be selected. That is, the Merrifield method, which is well-known as a method for producing a synthetic peptide, may be used in which beads of a polystyrene polymer gel having a diameter of around 0.1 mm and the like are used as a solid phase, amino acids are bonded thereto and subsequently condensed, and the end groups are deprotected to thereby elongate amino acid chains one by one.

### Third Polyamide Synthesis Method

A third polyamide synthesis method is for example a method of condensing a diamine and a dicarboxylic acid. Examples of the diamine include 1,2-ethylene diamine, 1,3-propane diamine, and 1,4-butylene diamine. Examples of the dicarboxylic acid include oxalic acid, malonic acid, and succinic acid.

### Other Synthesis Methods for Polyamides

In case of the polyamide is polyamide 3, the polyamide 3 may be synthesized by, for example, a hydrogen transfer polymerization method of acrylamides.

Furthermore, the method for synthesizing the polyamide 4 is described, for example, in the Non-Patent Document 1 of “Alkali-catalyzed polymerization of α-pyrrolidone in the presence of N,N′-adipyl-dipyrrolidone”, Masakazu TANIYAMA, Takashi NAGAOKA, Toshihiro TAKADA, Kazunori SANUYAMA, Journal of the Chemical Society of Japan, Industrial Chemistry Section, Vol. 65, No. 3, 1962, pp. 419-422. More specifically, the polyamide 4 can be obtained by the following procedure. That is, a small amount of sodium metal is reacted with α-pyrrolidone, and an anionic species is generated for some of the α-pyrrolidone. N-acylated pyrrolidone is then added as an initiator thereto, thereby the ring-opening reaction of pyrrolidone proceeds continuously, and an aggregate of polyamide 4 can be obtained.

### (2) Dissolution Step

The dissolution step according to the present embodiment includes dissolving a polyamide having the structure described above in hot water.

In the dissolution step, the polyamide is preferably added to hot water so that the concentration of the polyamide in the hot water is from 0.1 wt % to 50 wt % and preferably from 1 wt % to 30 wt %. By setting the amount of the polyamide that is added to hot water to be within the aforementioned range, non-spherical particles are easily obtained.

In the dissolution step, the temperature of the hot water is preferably from 100° C. to 200° C., more preferably from 100° C. to 180° C., and most preferably from 130° C. to 160° C. From the perspective of solubility of the polyamide in hot water, the temperature of the hot water is preferably within the range described above.

In the present embodiment, after the polyamide is added to the hot water, the polyamide is preferably dissolved while maintaining the temperature of the hot water. Furthermore, the time required for dissolution may be determined appropriately based on the temperature of the hot water, the concentration of the polyamide, and the molecular weight of the polyamide.

Note that the dissolution step may be a step in which the polyamide is added to water and then heated to a predetermined temperature to dissolve.

### (3) Precipitation Step

In the precipitation step, after the dissolution step described above, the solution in which the polyamide is dissolved in hot water (hereinafter, referred to as a polyamide solution) is cooled under stirring. Examples of the cooling method include, but are not limited to, (i) a process in which the polyamide solution is placed at room temperature (approximately 23° C.) and cooled naturally, (ii) a process in which the polyamide solution is placed at room temperature (approximately 23° C.) and cooled with blown air using an air blower or the like to blow air onto a device or container, and (iii) a process in which the device or container is placed in an ice-water bath and cooled. Another example is a process in which the polyamide solution is placed in an environment at an ambient temperature that is lower than room temperature (approximately 23° C.). Note that with respect to the cooling processes of (i) to (iii), ice cooling provides the fastest cooling rate, followed by blown air cooling, and natural cooling has the slowest cooling rate.

From the perspective of suppressing variations in the circularity and variations in the particle size distribution, cooling is preferably performed with a cooling process that provides a faster cooling rate than that of natural cooling. Therefore, cooling is preferably performed by, for example, blown air cooling or ice cooling. When cooling is performed at a faster rate than that of natural cooling, the CV value of the circularity of the polyamide particles is reduced, and the D90/D50 value of the particle size is smaller compared to natural cooling. That is, compared to a case where the obtained polyamide particles are cooled by natural cooling, variations in the circularity and particle size of the obtained polyamide particles are reduced. Furthermore, when cooling is performed by ice cooling, the circularity and particle size of the polyamide particles are smaller compared to cooling by blown air.

In the precipitation step of the present embodiment, stirring is performed when cooling the polyamide solution. The stirring speed is not particularly limited as long as the stirring speed is of an extent at which the polyamide solution is in a fluid state when the polyamide particles are precipitated and at which settling of the precipitated polyamide particles does not occur. Moreover, the stirring speed may be adjusted, as appropriate, in accordance with the volume of the container, the amount of the polyamide solution, the amount of the polyamide that is dissolved, and the like.

Polyamide particles in which the particles are non-spherical and in which the particle size distribution and circularity distribution are sharp, that is, the magnitude of the particle size and the circularity are made uniform can be provided by including the polymerization step, the dissolution step, and the precipitation step described above in the method for producing polyamide particles of the present embodiment.

### SUMMARY

As described above, the polyamide particles according to an embodiment of the present invention include a polyamide including repeating structural units having at least one alkylene group and at least one amide bond, each of the at least one alkylene group having 1 to 3 carbon atoms; and the polyamide particles have a configuration in which the main shape of the particles is a non-spherical shape with a circularity of less than 0.98 and in which a coefficient of variation (CV) of the circularity distribution is 30% or less.

In addition, the polyamide particles according to an embodiment of the present invention preferably have a D90/D50 value of the particle size distribution of 10 or less.

In addition, the polyamide particles according to an embodiment of the present invention preferably have a D90/D50 value of the particle size distribution of 5 or less.

Additionally, with respect to the polyamide particles according to an embodiment of the present invention, the structural unit is preferably represented by the above-described Formula (1).

Additionally, with respect to the polyamide particles according to an embodiment of the present invention, the structural unit is preferably represented by the above-described Formula (2).

The method for producing polyamide particles according to an embodiment of the present invention is configured to include: a polymerization step of preparing, through polymerization, a polyamide including repeating structural units having at least one alkylene group and at least one amide bond, each of the at least one alkylene group having 1 to 3 carbon atoms; a dissolution step of dissolving the polyamide obtained in the polymerization step in hot water; and a precipitation step of precipitating particles of the polyamide by cooling a solution obtained in the dissolution step under stirring.

Furthermore, in the above-described precipitation step of the method for producing polyamide particles according to an embodiment of the present invention, the solution is preferably cooled at a faster cooling rate than that of natural cooling.

Embodiments of the present invention will be described in further detail hereinafter using examples. The present invention is not limited to the examples below, and it goes without saying that various aspects are possible with regard to the details thereof. Furthermore, the present invention is not limited to the embodiments described above, and various modifications are possible within the scope defined by the claims. Embodiments obtained by appropriately combining the technical means disclosed by the embodiments are also included in the technical scope of the present invention. In addition, all of the documents disclosed in the present specification are herein incorporated by reference.

### EXAMPLES

### Method for Synthesizing Polyamide 4

Polyamide 4 (hereinafter, also referred to as “PA4”) was synthesized according to the synthesis method described in the Non-Patent Document 1 of “Alkali-catalyzed polymerization of α-pyrrolidone in the presence of N,N′-adipyl-dipyrrolidone”, Masakazu TANIYAMA, Takashi NAGAOKA, Toshihiro TAKADA, Kazunori SANUYAMA, Journal of the Chemical Society of Japan, Industrial Chemistry Section, Vol. 65, No. 3, 1962, pp. 419-422. More specifically, 1 mol % of sodium (Na) metal was added to α-pyrrolidone in a sealed flask in a 50° C. hot water bath. After the sodium dissolved, 0.1 mol % of N,N′-adipyl-dipyrrolidone was added as an initiator. The system immediately became cloudy and became difficult to be stirred soon. At ten hours after the stirring was stopped, the aggregate produced in the flask was removed and pulverized, after which the unreacted product and low-molecular weight substance were washed with acetone. The aggregate was then dried, and a powdery PA4 was obtained.

The weight average molecular weight (Mw) of the obtained PA4 was 96000. The weight average molecular weight was measured using the following procedure, analysis device and conditions.

### Measurement Procedure:

In hexafluoroisopropanol (HFIP) in which sodium trifluoroacetate was dissolved at a concentration of 5 mM, 10 mg of the PA4 sample obtained as described above was dissolved to prepare a solution of 10 cm³, and then the solution was filtered using a membrane filter to obtain a sample solution. An amount of 10 μl of the sample solution was injected into the analysis device described below, and the weight average molecular weight of the PA4 was measured under the measurement conditions described below.
Analyzer: gel permeation chromatography (GPC) analysis device (GPC104, available from Showa Denko K.K.)
Measurement Conditions:
A) SHODEX 104 System
B) Column: Showa Denko HFIP 606×2 in series, 40° C.
C) 5 mM CF₃COONa/HFIP, 0.1 mL/min
D) Detector: RI
E) 10 to 11 mg of sample/5 mM CF₃COONa/10 mL of HFIP
F) Calibration (in terms of PMMA) using a PMMA standard substance (150 E4, 65.9 E4, 21.8 E4, 4.96 E4, 2.06 E4, 0.68 E4, 0.2 E4).

### Example 1

PA4 and 400 mL of deionized water were added to a pressure resistant container having a volume of 1 L such that the concentration of PA4 with respect to deionized water was 1 wt %, and the mixture was heated to an internal temperature of 150° C. and then left for 6 hours. Subsequently, while stirring was performed at a rotational speed of 300 rpm, the hot water in which the PA4 was dissolved was cooled using a blower to blow air onto the pressure resistant container until the hot water reached room temperature (23° C.), and a suspension solution in which PA4 fine particles were dispersed in water was obtained. The obtained suspension solution was filtered using filter paper, and the obtained product was dried to obtain PA4 fine particles.

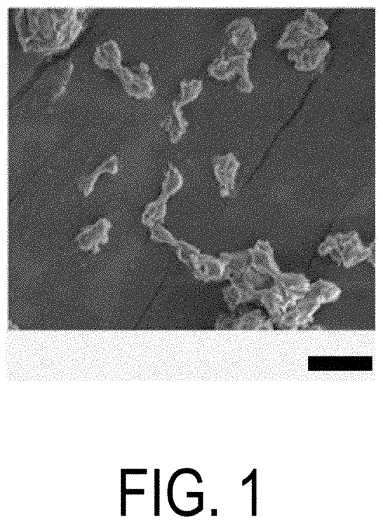

The obtained particles were observed with a scanning electron microscope (SEM) using a NeoScope JCM-5000 (available from JEOL Ltd.) under conditions including an accelerating voltage of 10 kV and a high vacuum pressure. As a result of the SEM observation, the PA4 fine particles were found to be irregularly shaped particles (see FIG. 1).

### Example 2

PA4 fine particles were obtained in the same manner as in Example 1 with the exception that the rotational speed of the stirring at the time of cooling was 50 rpm.

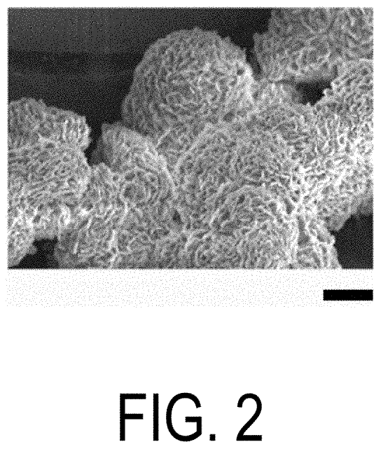

As a result of SEM observations performed on the particles obtained in the same manner as in Example 1, the PA4 fine particles were found to be irregularly shaped particles (see FIG. 2).

### Example 3

PA4 and 400 mL of deionized water were added to a pressure resistant container having a volume of 1 L such that the concentration of PA4 with respect to deionized water was 1 wt %, and the mixture was heated to an internal temperature of 150° C. and then left for 6 hours. Subsequently, while stirring was performed at a rotational speed of 300 rpm, the hot water in which the PA4 was dissolved was naturally cooled until the hot water reached room temperature (23° C.), and a suspension solution in which PA4 fine particles were dispersed in water was obtained. The obtained suspension solution was filtered using filter paper, and the obtained product was dried to obtain PA4 fine particles.

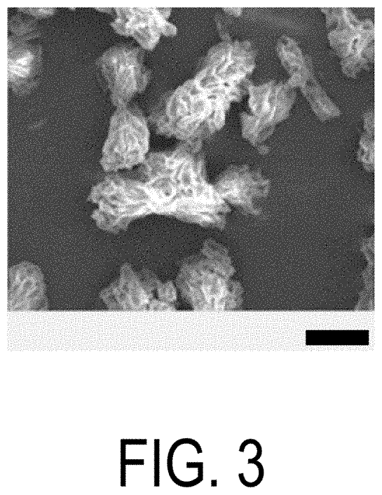

As a result of SEM observations performed on the particles obtained in the same manner as in Example 1, the PA4 fine particles were found to be irregularly shaped particles (see FIG. 3).

### Example 4

PA4 and 400 mL of deionized water were added to a pressure resistant container having a volume of 1 L such that the concentration of PA4 with respect to deionized water was 1 wt %, and the mixture was heated to an internal temperature of 180° C. Next, while stirring was performed at a rotational speed of 100 rpm, the hot water in which the PA4 was dissolved was cooled with an ice-water bath until the hot water reached room temperature (23° C.), and a suspension solution in which PA4 fine particles were dispersed in water was obtained. The obtained suspension solution was filtered using filter paper, and the obtained product was dried to obtain PA4 fine particles.

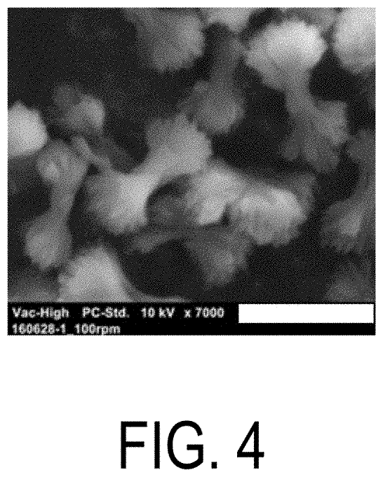

As a result of SEM observations performed on the particles obtained in the same manner as in Example 1, the PA4 fine particles were found to be irregularly shaped particles (see FIG. 4).

### Example 5

PA4 fine particles were obtained in the same manner as in Example 4 with the exception that the rotational speed of the stirring at the time of cooling was 300 rpm.

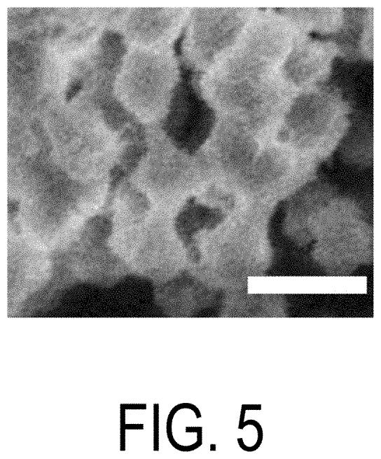

As a result of SEM observations performed on the particles obtained in the same manner as in Example 1, the PA4 fine particles were found to be irregularly shaped particles (see FIG. 5).

### Example 6

PA4 fine particles were obtained in the same manner as in Example 4 with the exception that the rotational speed of the stirring at the time of cooling was 600 rpm.

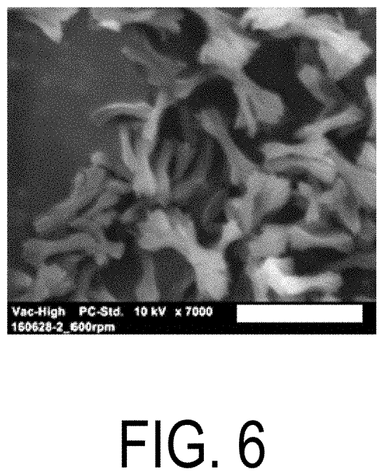

As a result of SEM observations performed on the particles obtained in the same manner as in Example 1, the PA4 fine particles were found to be rod-shaped spherical particles (see FIG. 6).

### Comparative Example 1

PA4 and 400 mL of deionized water were added to a pressure resistant container having a volume of 1 L such that the concentration of PA4 with respect to deionized water was 1 wt %, and the mixture was heated to an internal temperature of 150° C. and then left for 6 hours. Subsequently, the hot water in which the PA4 was dissolved was naturally cooled without stirring until the hot water reached room temperature (23° C.), and a suspension solution in which PA4 fine particles were dispersed in water was obtained. The obtained suspension solution was filtered using filter paper, and the obtained product was dried to obtain PA4 fine particles.

As a result of SEM observations performed on the particles obtained in the same manner as in Example 1, the PA4 fine particles were found to be spherical particles.

### Measurement of Circularity and Particle Size Distribution

Deionized water was added to the obtained PA4 fine particles, and the mixture was subjected to an ultrasonic treatment for 10 minutes, after which the circularity and particle size were measured under the following conditions using a wet-flow particle size analyzer (FPIA-3000: Sysmex Corporation). Based on the measurement results, the average value of the circularity, the CV value, and the D90/D50 value of the particle size distribution were calculated. The results are shown in Table 1.

Measurement mode: HPF

Count method: total count

Sheath Liquid: particle sheath

Objective lens: standard (10×)

Optical system: bright visual field

### Sphericity Measurement

Sphericity measurements were performed for Example 6 and Comparative Example 1, for which measurements were possible. The results are shown in Table 1.

TABLE 1

| | | | | | | CV | |
|---|---|---|---|---|---|---|---|
| | Cooling | Stirring | Particle | | Average | value | D90/ |
| | method | speed | shape | Sphericity | circularity | (%) | D50 |
| Example 1 | Blown air | 300 rpm | Irregularly | Difficult | 0.88 | 22.2 | 3 |
| | cooling | | shaped | to measure | | | |
| Example 2 | Blown air | 50 rpm | Irregularly | Difficult | 0.79 | 24.3 | 3.5 |
| | cooling | | shaped | to measure | | | |
| Example 3 | Room | 300 rpm | Irregularly | Difficult | 0.65 | 28.7 | 5.9 |
| | temperature | | shaped | to measure | | | |
| | cooling | | | | | | |
| Example 4 | Ice cooling | 100 rpm | Irregularly | Difficult | 0.79 | 23.5 | 1.5 |
| | | | shaped | to measure | | | |
| Example 5 | Ice cooling | 300 rpm | Irregularly | Difficult | 0.89 | 12.3 | 1.9 |
| | | | shaped | to measure | | | |
| Example 6 | Ice cooling | 600 rpm | Spherical | 28 | 0.79 | 20 | 2 |
| Comparative | Room | — | Spherical | 99 | 0.82 | 19.2 | 2.7 |
| Example 1 | temperature | | | | | | |
| | cooling | | | | | | |

### INDUSTRIAL APPLICABILITY

The present invention can be used in fields that use polyamide 4 and other such polyamides.

1. A method for producing polyamide particles, the method comprising:
a polymerization step of preparing, through polymerization, a polyamide that comprises repeating structural units having at least one alkylene group and at least one amide bond, each of the at least one alkylene group having 1 to 3 carbon atoms;
a dissolution step of dissolving the polyamide obtained in the polymerization step in hot water; and
a precipitation step of precipitating particles of the polyamide by cooling a solution obtained in the dissolution step under stirring.

2. The method for producing polyamide particles according to claim 1, wherein, in the precipitation step, the solution is cooled at a faster cooling rate than that of natural cooling.
